(19) United States
(12) Patent Application Publication
(10) Pub. No.: US 2025/0012587 A1
(43) Pub. Date: Jan. 9, 2025

(54) PROVIDING INVERTED DIRECTIONS AND OTHER INFORMATION BASED ON A CURRENT OR RECENT JOURNEY

(71) Applicant: GOOGLE LLC, Mountain View, CA (US)

(72) Inventor: Matthew Sharifi, Mountain View, CA (US)

(21) Appl. No.: 18/275,745

(22) PCT Filed: Sep. 29, 2022
(86) PCT No.: PCT/US2022/045184

§ 371 Date: Aug. 3, 2023

(51) Int. Cl. G01C 21/36; G01C 21/34

(52) U.S. Cl. CPC G01C 21/3617; G01C 21/3469; G01C 21/3629

(57) ABSTRACT

A computing device may implement a method for providing route information regarding a completed or ongoing trip by a user without the user having previously initiated a navigation session. The method may include receiving a query regarding a previous or ongoing trip by a user prior to the user initiating a navigation session; determining an origin for the previous or ongoing trip; obtaining route information for the previous or ongoing trip; generating one or more route attributes associated with the query based at least on the origin for the previous or ongoing trip and the route information for the previous or ongoing trip; and providing a response to the query based at least on the one or more route attributes.

### FIELD OF THE DISCLOSURE

The present disclosure generally relates to navigation systems and, more particularly, to providing responses to queries regarding an ongoing or recently completed trip before the user has initiated a navigation session.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many users request map and navigation data for various geographic locations. Software applications executing in computers, smartphones, embedded devices, etc., generate step-by-step navigation directions in response to receiving input from a user, specifying the starting point and the destination. The navigation directions are typically generated for a route which guides the user to and from the destination in the shortest amount of time.

### SUMMARY

In some scenarios, such as when a user is familiar with the route from the user's starting location (e.g., their home) to a destination (e.g., their place of work) or when a user has no particular destination in mind, the user does not request navigation directions and does not initiate a navigation session via a mapping application. However, after completing the route or when planning to return, the user may have questions about a return trip. For example, if a user does not remember the route the user took, the user may want to know how to return to a point of origin. In another example, the user may pass a location, such as a restaurant, and later decide to return to the location in question.

To receive answers to these questions without having to initiate a navigation session, an ad-hoc query response system may receive a query regarding the current trip from the user prior to initiating a navigation session. For example, the query may be, “Hey Maps, can you take me back home?” The ad-hoc query response system may determine or retrieve the path the user took to reach the current location and provide directions back to a determined point of origin. In some scenarios, the ad-hoc query response system may determine the point of origin based on the query (e.g., “home”). In further scenarios, the point of origin may be a location of a particular event or the navigation system may use the location of the particular event to determine a first part of a return route before using the point of origin for the remainder. In other scenarios, the ad-hoc query response system may infer the point of origin based on user context data, such as calendar events, the user's typical destinations or points of origin at the particular day of the week/time of day, etc. In still further implementations, the navigation system may determine the point of origin after determining a change in speed (e.g., from walking speed to driving speed), a change in distance (e.g., more than a predetermined threshold distance away from a saved location such as home or work), some combination thereof, etc.

Route information pertaining to the user's current or most recent trip may be stored locally on the user's device, for example cached on the user's device. The route information may include a turn-by-turn record of the user's current or most recent trip may be stored locally on the user's device. A determined point of origin for the trip may also be stored on the user's device, for example cached on the user's device. Based on the point of origin and/or the user's stored route information, the ad-hoc query response system may generate a set of navigation directions from the user's current location to the determined point of origin for providing a response to the query. For example, if the user followed a path along a highway before taking a detour through a residential area, the navigation directions will lead the user on a reverse return trip through the same residential area and onto the highway. In some implementations, the ad-hoc query response system eliminates redundancies, such as unnecessary loops, from the directions.

The ad-hoc query response system then analyzes the set of navigation directions using attributes from the query to provide a response to the query. For example, in response to the user's query as to whether they took an optimal route, the ad-hoc query response system analyzes the stored route information, determines a recommended hindsight route for the user (e.g., based on speed, gas usage, etc.), and determines whether any improvements are present in the recommended hindsight route compared to the stored route information. Then the ad-hoc query response system provides a response to the user indicating whether the user took an optimal route. For example, the response may be an audio response confirming that the user is correct and took an optimal route. The response may also be a text or visual response indicating that the user is correct and took an optimal route. If the user did not take an optimal route, the response may indicate that the user did not take an optimal route and may ask the user if they would like to receive an improved route for the return trip and/or for the next trip. The response may also indicate which part(s) of the route were suboptimal, such as by noting the relevant portions of the route aloud (e.g., “You left Route 59 one exit too soon,”), by indicating the taken route and the improved route on a display, etc. Then the ad-hoc query response system may initiate a navigation session and provide audio and/or visual navigation instructions to the user.

In some scenarios, the ad-hoc query response system may analyze the route to determine the time and/or distance the user travelled in response to the user query. Then the ad-hoc query response system may provide a response to the user indicating the total time or distance traveled in the completed route or trip. Further, the ad-hoc query response system may calculate a time that the user needs to leave (e.g., to reach a bus stop on time) in response to the user query and based on the travel time and/or distance. The ad-hoc query response system may then alert a user when the user needs to leave to reach the location on time.

By providing responses to requests for navigation information during or after a current trip but prior to initiating a navigation session, the user does not need to initiate a navigation session at the beginning of a route to track the locations or route travelled. This saves battery power on the user's client device as well as processing power and bandwidth requirements at least for the portion(s) of the trip where the user does not initiate a navigation session. Additionally, this reduces unnecessary distraction for the user when the user wants to return to a previous location but otherwise is familiar with the rest of the trip. This also increases driver safety by preventing a driver from having to initiate a navigation session to return to the origin point if the driver is lost or otherwise unsure of the next maneuver to return to a location, for example. Moreover, the ad-hoc query response system further reduces bandwidth requirements by caching route information and using the cached route information, in some scenarios, to respond to a query rather than obtaining navigation directions from a server.

One example embodiment of the techniques of this disclosure is a method for providing route information regarding a completed or ongoing trip by a user without the user having previously initiated a navigation session. The method includes: (i) receiving a query regarding a previous or ongoing trip by a user prior to the user initiating a navigation session; (ii) determining an origin for the previous or ongoing trip; (iii) obtaining route information for the previous or ongoing trip; (iv) generating one or more route attributes associated with the query based at least on the origin for the previous or ongoing trip and the route information for the previous or ongoing trip; and (v) providing a response to the query based at least on the one or more route attributes.

Another example embodiment is a computing device for providing route information regarding a completed or ongoing trip by a user without the user having previously initiated a navigation session. The computing device includes one or more processors, and a computer-readable memory, which is optionally non-transitory, coupled to the one or more processors and storing instructions thereon that, when executed by the one or more processors, cause the computing device to: (i) receive a query regarding a previous or ongoing trip by a user prior to the user initiating a navigation session; (ii) determine an origin for the previous or ongoing trip; (iii) obtain route information for the previous or ongoing trip; (iv) generate one or more route attributes associated with the query based at least on the origin for the previous or ongoing trip and the route information for the previous or ongoing trip; and (v) provide a response to the query based at least on the one or more route attributes.

Yet another example embodiment is a computer-readable medium, which is optionally non-transitory, storing instructions for providing route information regarding a completed or ongoing trip by a user without the user having previously initiated a navigation session, that when executed by one or more processors cause the one or more processors to: (i) receive a query regarding a previous or ongoing trip by a user prior to the user initiating a navigation session; (ii) determine an origin for the previous or ongoing trip; (iii) obtain route information for the previous or ongoing trip; (iv) generate one or more route attributes associated with the query based at least on the origin for the previous or ongoing trip and the route information for the previous or ongoing trip; and (v) provide a response to the query based at least on the one or more route attributes.

In some examples, the origin for the previous or ongoing trip may be determined by detecting a trip start event in a recent log of the user's behavior. The recent log of the user's behavior may be a recent log of the user's location, for example a recent GPS log of the user's location. However, other user behaviors may be used. For example, the origin may be determined by detecting the user entering a vehicle, or by detecting the start of a walking activity. In some examples, detection of a trip start event may trigger a caching of the user's location or trajectory, for example a local caching of the user's location or trajectory.

### BRIEF DESCRIPTION OF THE DRAWINGS

FIG. 1 is a block diagram of an example communication system, including a user device, in which techniques for providing route information regarding a completed or ongoing trip by a user can be implemented;

FIG. 2 illustrates an example scenario within a vehicle interior where a user requests navigation information to return to a point of origin without previously initiating a navigation session from a user device, such as the user device of FIG. 1;

FIG. 3 illustrates another example scenario within a vehicle interior where a user queries the user device of FIG. 1 as to whether the user took an optimal path without previously initiating a navigation session;

FIG. 4A illustrates an example interaction between the user and the user device of FIG. 1, where the user queries the user device as to how far the user has walked;

FIG. 4B illustrates an example interaction similar to that of FIG. 4A, but in which the user queries the user device as to how long the user has been walking rather than how far the user has walked;

FIG. 5 illustrates another example interaction between the user and the user device of FIG. 1, where the user queries the user device as to how long ago an event took place and how long it will take to return to the event location;

FIG. 6 illustrates yet another example interaction between the user and the user device of FIG. 1, where the user asks the user device to tell the user when to leave to return back to an origin by a given time;

FIG. 7 illustrates still yet another example interaction between the user and the user device of FIG. 1, where the user device provides a text prompt answering the query and asking if the user wishes to initiate a navigation session; and

FIG. 8 is a flow diagram of an example method for providing route information regarding a completed or ongoing trip by a user without the user having previously initiated a navigation session, which can be implemented in a computing device, such as the user computing device of FIG. 1.

### DETAILED DESCRIPTION

### Overview

Generally speaking, the techniques for providing navigation information regarding a current trip or recently completed trip by a user without the user having previously initiated a navigation session can be implemented in one or several user computing devices, one or several network servers, or a system that includes a combination of these devices. However, for clarity, the examples below focus primarily on an embodiment in which a user on a current trip provides a query regarding a previous or ongoing trip to a user computing device. As used herein, a “previous or ongoing trip” may refer to a trip in which the user is currently engaged, a trip which the user has temporarily paused, a trip which the user has most recently taken, a trip which the user took previously and is stored in memory, etc.

The user computing device may analyze the query using, for example, natural language processing techniques, to determine whether an origin or a point-of-interest (POI) is included in the query. The user computing device may also analyze previous queries and/or user context data, such as calendar events, the user's typical trips at the particular day of the week/time of day, etc. to determine the origin of the current trip. In still further implementations, the user computing device may determine the point of origin or POI after determining a change in speed (e.g., from walking speed to driving speed), a change in distance (e.g., more than a predetermined threshold distance away from a saved location such as home or work), some combination thereof, etc.

The user computing device may also determine the current location of the user computing device, for example, using sensor data from sensors in the user computing device. For example, the user computing device may determine various points-of-interest that the user passes while traversing a current trip. The user computing device may provide the current location, points-of-interest, and/or origin to an external server.

The external server may generate set(s) of navigation directions from the current location to the origin based on the stored locations of the user computing device, the points-of-interest, etc. In some implementations, the external server analyzes the stored locations, the points-of-interest, the origin, and/or set(s) of navigation directions used by a user using attributes from the query to generate a response to the query. The external server may then provide the response to the query to the user computing device. In other implementations, the external server provides the stored locations, the points-of-interest, the origin, and/or set(s) of navigation directions to the user computing device. The user computing device then analyzes the stored locations, the points-of-interest, the origin, and/or set(s) of navigation directions using attributes from the query to generate a response to the query. Then the user computing device presents the response to the user as an audio response and/or a visual response, via a user interface of the user computing device.

The techniques as described herein offer benefits over traditional systems for generating navigation directions to a user. For example, by providing responses to requests for navigation information prior to initiating a navigation session, the user does not need to initiate a navigation session at the beginning of a route. As such, a client device saves battery power, processing power, bandwidth requirements, etc. for portions of the trip where the user has not engaged the navigation session. Further, removing the need to initiate a navigation session reduces unnecessary distraction for the user when the user wants to return to a previous location but otherwise is familiar with the rest of the trip and improves driver safety by preventing the driver from having to initiate the navigation session. Moreover, by caching route information and using the cached route information, the ad-hoc query response system reduces bandwidth requirements.

### Example Hardware and Software Components

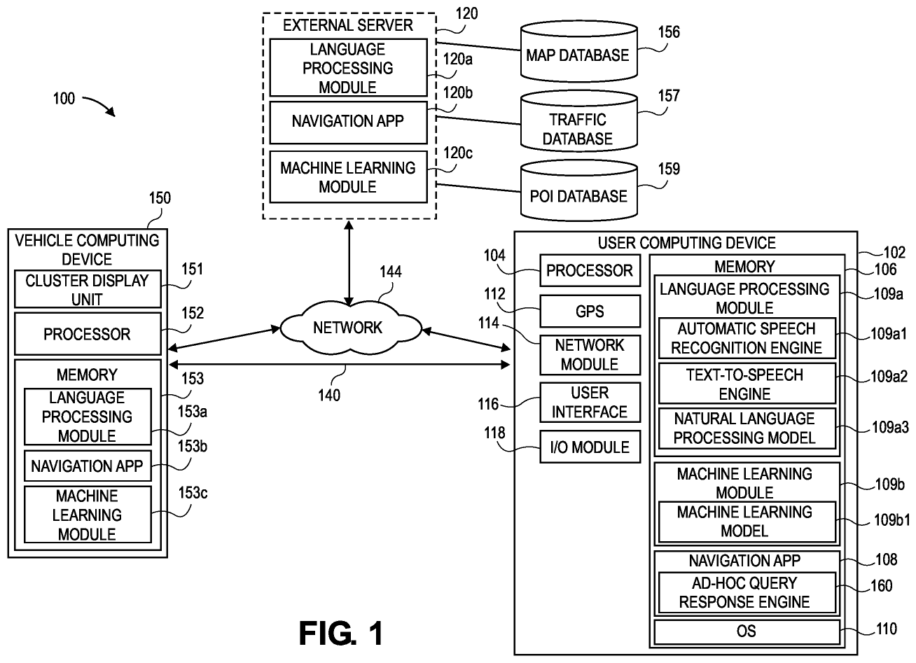

Referring to FIG. 1, an example communication system 100, in which techniques for providing ad-hoc navigation information can be implemented, includes a user computing device 102. The user computing device 102 may be a portable device such as a smart phone or a tablet computer, for example. The user computing device 102 may also be a laptop computer, a desktop computer, a personal digital assistant (PDA), a wearable device such as a smart watch or smart glasses, a virtual reality headset, etc. In some embodiments, the user computing device 102 may be removably mounted in a vehicle, embedded into a vehicle, and/or may be capable of interacting with a head unit of a vehicle to provide navigation instructions.

The user computing device 102 may include one or more processor(s) 104 and a memory 106 storing machine-readable instructions executable on the processor(s) 104. The processor(s) 104 may include one or more general-purpose processors (e.g., CPUs), and/or special-purpose processing units (e.g., graphical processing units (GPUs)). The memory 106 can be, optionally, a non-transitory memory and can include one or several suitable memory modules, such as random access memory (RAM), read-only memory (ROM), flash memory, other types of persistent memory, etc. The memory 106 may store instructions for implementing a navigation application 108 that can provide navigation directions (e.g., by displaying directions or emitting audio instructions via the user computing device 102), display an interactive digital map, request and receive routing data to provide driving, walking, or other navigation directions, provide various geo-located content such as traffic, points-of-interest (POIs), and weather information, etc. While the examples described herein for providing ad-hoc navigation information include driving information, the techniques may be applied to navigation information for any suitable mode of transportation, such as walking. biking, public transportation, etc.

The navigation application 108 may include an ad-hoc query response engine 160. The ad-hoc query response engine 160 may receive audio or text queries from a user for route information regarding the user's current trip or completed trip when the user has not initiated a navigation session for the current or completed trip. The user may provide a particular trigger phrase or hot word which causes the ad-hoc query response engine 160 to receive the audio query from the user, such as “Hey Maps.” The ad-hoc query response engine 160 may then analyze the query using the natural language processing techniques described below to identify a point of origin, a point-of-interest, and/or other attributes included in the query.

When the query does not include an origin, the ad-hoc query response engine 160 may infer the origin according to other data retrieved by the ad-hoc query response engine 160. For example, the ad-hoc query response engine 160 may obtain data from a GPS 112 or other sensor, stored at the user computing device 102 or at the external server 120, to determine that a user began moving. The ad-hoc query response engine 160 may then determine that the point where the user began moving is the origin. Similarly, the ad-hoc query response engine 160 may determine that a point where a user began moving above a threshold speed to be the point of origin (e.g., a user begins driving, using public transit, biking, etc.) or that a point where the user crosses beyond a threshold distance to be the point of origin. The ad-hoc query response engine 160 may also obtain user context data stored at the user computing device 102 or at the external server 120 to infer the origin, such as calendar data, typical trips taken at the particular day of the week/time of day, etc. Similarly, the query response engine 160 may determine that a user has completed the trip when the user stops moving for a pre-determined period of time, begins moving below the threshold speed for a pre-determined period of time, has reached a POI, has indicated the trip is complete, etc. In still further implementations, multiple factors are fed into a machine learning model as described in more detail below. In such implementations, the machine learning model generates a confidence score based on the input factors to determine whether the user has begun a trip.

In some implementations, the origin is represented by the ad-hoc query response engine 160 as an identifier (e.g., a location ID), a latitude and longitude pair, etc. In further implementations, the identifier for the origin is stored locally. In still further implementations, the identifier for the origin is consistent locally (e.g., on the device), but may not be consistent globally or according to a greater network. For example, if a location has an identifier that is used on a network or between applications, the local identifier may be different so long as it is consistent on the device itself. Depending on the implementation, the ad-hoc query response engine 160 may similarly identify POIs, events, etc. using the same techniques.

In further implementations, the ad-hoc query response engine 160 verifies the origin and/or trip status after a predetermined period of time and/or distance travelled to determine that the origin is not a false positive. In some such implementations, the time spent traveling, distance from the origin, actual distance traveled, etc. may be used to verify the origin and/or trip status.

After determining or inferring the point of origin and/or completing a trip, the ad-hoc query response engine 160 may transmit a request for navigation directions to the external server 120 from the user's current location to the origin using past route information. The ad-hoc query response engine 160 may then receive one or more set(s) of navigation directions to the origin from the external server 120 and may analyze the set(s) of navigation directions to provide a response to the query regarding a previous or ongoing trip. In other implementations, the ad-hoc query response engine 160 may obtain an offline set(s) of navigation directions cached at the user computing device 102 and obtained from the external server 120 in a previous request, for example. In some implementations, the user computing device 102 obtains and/or caches location data, navigation directions, route information, etc. locally and performs analysis of the data locally. In further implementations, the computing device 102 stores the route information, location data, etc. for a predetermined period of time locally before erasing the information and/or causing the information to be stored elsewhere (e.g., on the external server 120, vehicle computing device 150, etc.).

In still other implementations, the ad-hoc query response engine 160 generates the set(s) of navigation directions using recorded locations, past navigation directions from the origin to the current location, etc. In some such implementations, the ad-hoc query response engine 160 generates the set(s) of navigation directions by inverting the route the user took as precisely as possible. For example, where the user took a one-way street, the ad-hoc query response engine 160 may provide navigation directions that pass as close to the one-way street as possible. Similarly, where the user took an east-bound bus, the ad-hoc query response engine 160 may provide navigation directions that include taking the west-bound bus from a close but different bus stop if necessary. In other implementations, the ad-hoc query response engine 160 provides an improved route that may be similar to the inverted route, as discussed herein.

In still further implementations, the ad-hoc query response engine 160, the navigation application 108 as a whole, software on the vehicle computing device 150, software on the external server 120, etc. keeps track of a user's location over time and stores a log of the information. For example, the navigation application 108 may include or access a timeline of events that includes the origin of a trip, any POIs along the trip, other events along the trip (such as turns on or off of a highway), etc. As such, the ad-hoc query response engine 160 may access the stored log of information to generate the route from the current location to the origin. In further implementations, the ad-hoc query response engine 160 may use the information stored in the log to determine route attributes and/or otherwise respond to a user query as described herein.

In yet further implementations, the navigation application 108, determines a trajectory of the user during an initial trip to determine a destination and/or a path to a location using location data, past route data, user context data, etc. In some such implementations, the ad-hoc query response engine 160 determines a return route based on the determined trajectory or trajectories. For example, the ad-hoc query response engine 160 determines navigation directions according to the determined trajectory for the initial trip and subsequently determines a return trip path according to the trajectory information. In further implementations, the ad-hoc query response engine 160 generates navigation directions for the initial trip and inverts the directions for the return trip path.

Further, the memory 102 may include a language processing module 109a configured to implement and/or support the techniques of this disclosure for providing ad-hoc navigation information through natural conversation. Namely, the language processing module 109a may include an automatic speech recognition (ASR) engine 109a1 that is configured to transcribe speech inputs from a user into sets of text. Further, the language processing module 109a may include a text-to-speech (TTS) engine 109a2 that is configured to convert text into audio outputs, such as audio responses, audio queries, navigation instructions, and/or other outputs for the user. In some scenarios, the language processing module 109a may include a natural language processing (NLP) model 109a3 that is configured to output textual transcriptions, intent interpretations, and/or audio outputs related to a speech input received from a user of the user computing device 102. It should be understood that, as described herein, the ASR engine 109a1 and/or the TTS engine 109a2 may be included as part of the NLP model 109a3 in order to transcribe user speech inputs into a set of text, convert text outputs into audio outputs, and/or any other suitable function described herein as part of a conversation between the user computing device 102 and the user.

Generally, the language processing module 109a may include computer-executable instructions for training and operating the NLP model 109a3. In general, the language processing module 109a may train one or more NLP models 109a3 by establishing a network architecture, or topology, and adding layers that may be associated with one or more activation functions (e.g., a rectified linear unit, softmax, etc.), loss functions and/or optimization functions. Such training may generally be performed using a symbolic method, machine learning (ML) models, and/or any other suitable training method. More generally, the language processing module 109a may train the NLP models 109a3 to perform two techniques that enable the user computing device 102, and/or any other suitable device (e.g., vehicle computing device 150) to understand the words spoken by a user and/or words generated by a text-to-speech program (e.g., TTS engine 109a2) executed by the processor 104: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (PoS) tagging, parsing, lemmatization and stemming, stop-word removal, and/or any other suitable sub-task or combinations thereof. For example, using syntactic analysis, the NLP model 109a3 may generate textual transcriptions from the speech inputs from the user. Additionally, or alternatively, the NLP model 109a3 may receive such textual transcriptions as a set of text from the ASR engine 109a1 in order to perform semantic analysis on the set of text.

Semantic analysis generally involves analyzing text in order to understand and/or otherwise capture the meaning of the text. In particular, the NLP model 109a3 applying semantic analysis may study the meaning of each individual word contained in a textual transcription in a process known as lexical semantics. Using these individual meanings, the NLP model 109a3 may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the NLP model 109a3 may generate one or more intent interpretations based on the textual transcriptions from the syntactic analysis.

In these aspects, the language processing module 109a may include an artificial intelligence (AI) trained conversational algorithm (e.g., the natural language processing (NLP) model 109a3) that is configured to interact with a user that is accessing the navigation app 108. The user may be directly connected to the navigation app 108 to provide verbal input/responses (e.g., speech inputs), and/or the user query may include textual inputs/responses that the TTS engine 109a2 (and/or other suitable engine/model/algorithm) may convert to audio inputs/responses for the NLP model 109a3 to interpret. When a user accesses the navigation app 108, the inputs/responses spoken by the user and/or generated by the TTS engine 109a2 (or other suitable algorithm) may be analyzed by the NLP model 109a3 to generate textual transcriptions and intent interpretations.

The language processing module 109a may train the one or more NLP models 109a3 to apply these and/or other NLP techniques using a plurality of training speech inputs from a plurality of users. As a result, the NLP model 109a3 may be configured to output textual transcriptions and intent interpretations corresponding to the textual transcriptions based on the syntactic analysis and semantic analysis of the user's speech inputs.

In certain aspects, one or more types of machine learning (ML) may be employed by the language processing module 109a to train the NLP model(s) 109a3. The ML may be employed by the ML module 109b, which may store a ML model 109b1. The ML model 109b1 may be configured to receive a set of text corresponding to a user input, and to output an intent based on the set of text. The NLP model(s) 109a3 may be and/or include one or more types of ML models, such as the ML model 109b1. More specifically, in these aspects, the NLP model 109a3 may be or include a machine learning model (e.g., a large language model (LLM)) trained by the ML module 109b using one or more training data sets of text in order to output one or more training intents and one or more training destinations, origins, and/or points-of-interest, as described further herein. For example, artificial neural networks, recurrent neural networks, deep learning neural networks, a Bayesian model, and/or any other suitable ML model 109b1 may be used to train and/or otherwise implement the NLP model(s) 109a3. In these aspects, training may be performed by iteratively training the NLP model(s) 109a3 using labeled training samples (e.g., training user inputs).

In instances where the NLP model(s) 109a3 is an artificial neural network, training of the NLP model(s) 109a3 may produce byproduct weights, or parameters which may be initialized to random values. The weights may be modified as the network is iteratively trained, by using one of several gradient descent algorithms, to reduce loss and to cause the values output by the network to converge to expected, or “learned”, values. In embodiments, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In embodiments, multiple artificial neural networks may be separately trained and operated, and/or separately trained and operated in conjunction.

In embodiments, the one or more NLP models 109a3 may include an artificial neural network having an input layer, one or more hidden layers, and an output layer. Each of the layers in the artificial neural network may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of artificial neural networks are possible. For example, the input layer may correspond to input parameters that are given as full sentences, or that are separated according to word or character (e.g., fixed width) limits. The input layer may correspond to a large number of input parameters (e.g., one million inputs), in some embodiments, and may be analyzed serially or in parallel. Further, various neurons and/or neuron connections within the artificial neural network may be initialized with any number of weights and/or other training parameters. Each of the neurons in the hidden layers may analyze one or more of the input parameters from the input layer, and/or one or more outputs from a previous one or more of the hidden layers, to generate a decision or other output. The output layer may include one or more outputs, each indicating a prediction. In some embodiments and/or scenarios, the output layer includes only a single output.

It is noted that although FIG. 1 illustrates the navigation application 108 as a standalone application, the functionality of the navigation application 108 also can be provided in the form of an online service accessible via a web browser executing on the user computing device 102, as a plug-in or extension for another software application executing on the user computing device 102, etc. The navigation application 108 generally can be provided in different versions for different operating systems. For example, the maker of the user computing device 102 can provide a Software Development Kit (SDK) including the navigation application 108 for the Android™ platform, another SDK for the iOS™ platform, etc.

The memory 106 may also store an operating system (OS) 110, which can be any type of suitable mobile or general-purpose operating system. The user computing device 102 may further include one or several sensors such as a global positioning system (GPS) 112 or another suitable positioning module, an accelerometer, a gyroscope, a compass, an inertial measurement unit (IMU), etc., a network module 114, a user interface 116 for displaying map data and directions, and input/output (I/O) module 118. The network module 114 may include one or more communication interfaces such as hardware, software, and/or firmware of an interface for enabling communications via a cellular network, a Wi-Fi network, or any other suitable network such as a network 144, discussed below. The I/O module 118 may include I/O devices capable of receiving inputs from, and providing outputs to, the ambient environment and/or a user. The I/O module 118 may include a touch screen, display, keyboard, mouse, buttons, keys, microphone, speaker, etc. In various implementations, the user computing device 102 can include fewer components than illustrated in FIG. 1 or, conversely, additional components.

The user computing device 102 may communicate with an external server 120 and/or a vehicle computing device 150 via a network 144. The network 144 may include one or more of an Ethernet-based network, a private network, a cellular network, a local area network (LAN), and/or a wide area network (WAN), such as the Internet. The navigation application 108 may transmit map data, navigation directions, and other geo-located content to the vehicle computing device 150 for display on the cluster display unit 151. Moreover, the user computing device 102 may be directly connected to the vehicle computing device 150 through any suitable direct communication link 140, such as a wired connection (e.g., a USB connection).

In certain aspects, the network 144 may include any communication link suitable for short-range communications and may conform to a communication protocol such as, for example, Bluetooth™ (e.g., BLE), Wi-Fi (e.g., Wi-Fi Direct), NFC, ultrasonic signals, etc. Additionally, or alternatively, the network 144 may be, for example, Wi-Fi, a cellular communication link (e.g., conforming to 3G, 4G, or 5G standards), etc. In some scenarios, the network 144 may also include a wired connection.

The external server 120 may be a remotely located server that includes processing capabilities and executable instructions necessary to perform some/all of the actions described herein with respect to the user computing device 102. For example, the external server 120 may include a language processing module 120a that is similar to the language processing module 109a included as part of the user computing device 102, and the module 120a may include one or more of the ASR engine 109a1, the TTS engine 109a2, and/or the NLP model 109a3. The external server 120 may also include a navigation app 120b and a ML module 120c that are similar to the navigation app 108 and ML module 109b included as part of the user computing device 102.

The ad-hoc query response engine 160 and the navigation app 120b or 108 can operate as components of an ad-hoc query response system. Alternatively, the ad-hoc query response system can include only server-side components and simply provide the ad-hoc query response engine 160 with responses to requests for navigation information. In other words, ad-hoc navigation techniques in these embodiments can be implemented transparently to the ad-hoc query response engine 160. As another alternative, the entire functionality of the navigation app 120b can be implemented in the ad-hoc query response engine 160.

Similarly, the language processing module 109a, 120a may include separate components at the user computer device 102 and the external server 120, can only include server-side components and provide language processing outputs to the ad-hoc query response engine 160, or the entire functionality of the language processing module 109a, 120a can be implemented at the user computing device 102. Additionally, the ML module 109b, 120c may include separate components at the user computer device 102 and the external server 120, can only include server-side components and provide ML outputs to the language processing module 109a, 120a, or the entire functionality of the ML module 109b, 120c can be implemented at the user computing device 102

The vehicle computing device 150 includes one or more processor(s) 152 and a memory 153 storing computer-readable instructions executable by the processor(s) 152. The memory 153 may store a language processing module 153a, a navigation application 153b, and a ML module 153c that are similar to the language processing module 153a, the navigation application 108, and the ML module 109b, respectively. The navigation application 153b may support similar functionalities as the navigation application 108 from the vehicle-side and may facilitate rendering of information displays, as described herein. For example, in certain aspects, the user computing device 102 may provide the vehicle computing device 150 with an accepted route that has been accepted by a user, and the corresponding navigation instructions to be provided to the user as part of the accepted route. The navigation application 153b may then proceed to render the navigation instructions within the cluster unit display 151 and/or to generate audio outputs that verbally provide the user with the navigation instructions via the language processing module 153a.

In any event, the external server 120 may be communicatively coupled to various databases, such as a map database 156, a traffic database 157, and a point-of-interest (POI) database 159, from which the external server 120 can retrieve navigation-related data. The map database 156 may include map data such as map tiles, visual maps, road geometry data, road type data, speed limit data, etc. The map database 156 may also include route data for providing navigation directions, such as driving, walking, biking, or public transit directions, for example. The traffic database 157 may store historical traffic information as well as real-time traffic information. The POI database 159 may store descriptions, locations, images, and other information regarding landmarks or points-of-interest. While FIG. 1 depicts databases 156, 157, and 159, the external server 120 may be communicatively coupled to additional, or conversely, fewer, databases. For example, the external server 120 may be communicatively coupled to a database storing weather data.

### Example Queries Regarding a Previous or Ongoing Trip

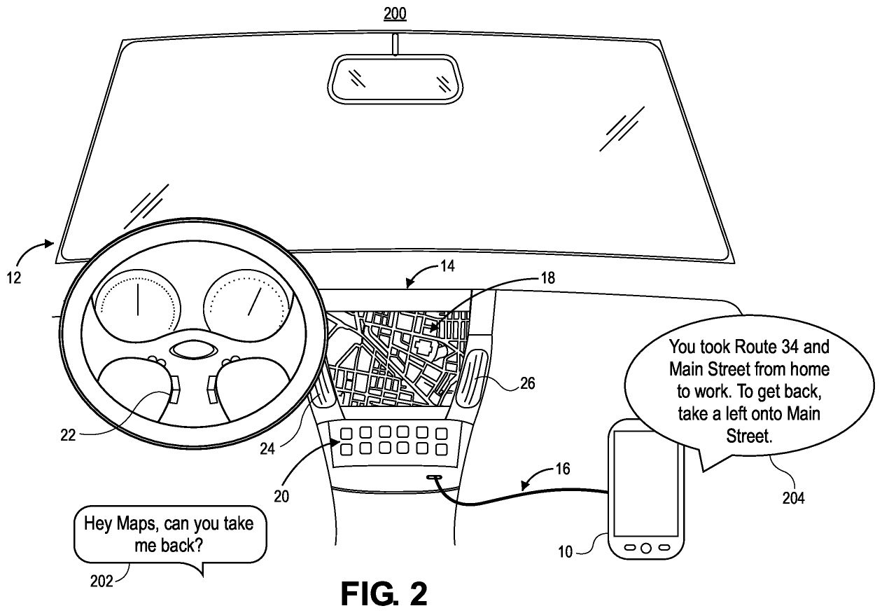

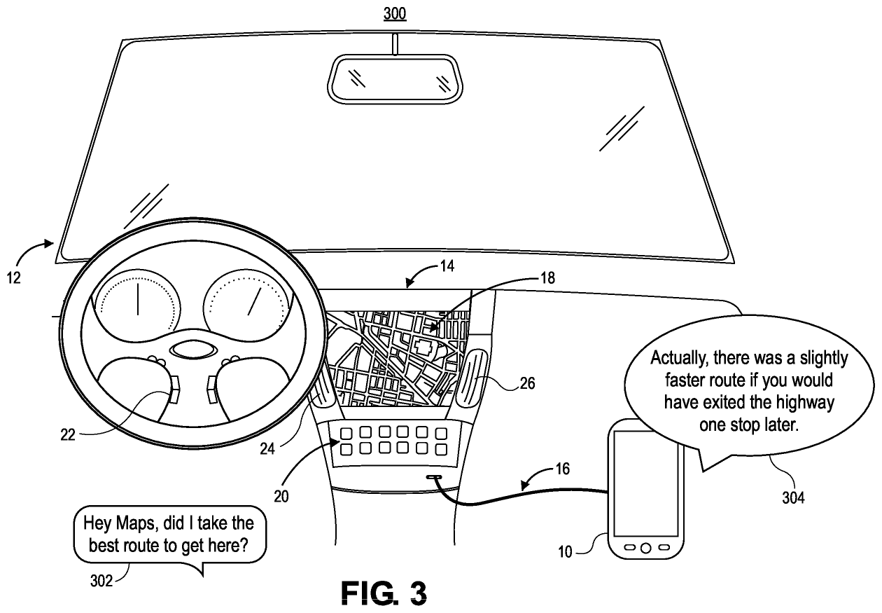

FIG. 2 illustrates an example scenario 200 where a user requests navigation information in a query without previously initiating a navigation session. The user query may be an audio query. More specifically, in the example of FIG. 2, the user asks, “Hey Maps, can you take me back?” 202. The user may be a driver, a front seat passenger, a back seat passenger in the vehicle 12, etc. While the example scenarios in FIGS. 2 and 3 include queries related to driving directions it will be understood that such examples are for ease of illustration only. The ad-hoc query response system can be used for any suitable mode of transportation including driving, walking, biking, or public transportation.

Additionally, while the example scenarios described herein are generally in the context of a speech based configuration, the ad-hoc query response system can also be used in the context of a touch-based or visual interface. For example, user queries regarding a previous or ongoing trip can be entered via free-form textual input or through UI elements (e.g. a drop-down menu). Responses to the user queries can be displayed to the user via the user interface. Embodiments disclosed herein that are described in the context of a speech-based interface may also be applied to the context of a touch-based interface. All embodiments disclosed herein in which inputs or outputs are described in the context of a speech-based interface may be adapted to apply to the context of a touch-based interface.

The example vehicle 12 in FIG. 2 includes a client device 10 and a head unit 14. The client device 10 communicates with the head unit 14 of the vehicle 12 via a communication link 16, which may be wired (e.g., Universal Serial Bus (USB)) or wireless (e.g., Bluetooth, Wi-Fi Direct). The client device 10 also can communicate with various content providers, servers, etc. via a wireless communication network such as a fourth- or third-generation cellular network (4G or 3G, respectively).

The head unit 14 can include a display 18 for presenting navigation information such as a digital map. The display 18 in some implementations is a touchscreen and includes a software keyboard for entering text input, which may include the name or address of a destination, point of origin, etc. Hardware input controls 20 and 22 on the head unit 14 and the steering wheel, respectively, can be used for entering alphanumeric characters or to perform other functions for requesting navigation directions. The head unit 14 also can include audio input and output components such as a microphone 24 and speakers 26, for example. The speakers 26 can be used to play audio instructions or audio notifications sent from the client device 10.

In the example scenario 200, the user has not initiated a navigation session. In other words, the user does not request navigation directions from the user's current location to the user's starting point prior to beginning the current trip from work back to home. In some implementations, the user has not launched the navigation application 108 and may simply begin interacting with the user computing device 102 by asking, “Hey Maps, can you take me back?” The phrase “Hey Maps” may be a hot word or trigger to activate the navigation application 108. In other implementations, the navigation application 108 may be activated and may continuously or periodically obtain location data for the user computing device 102 for example, to determine past locations of the user computing device 102 along a trip to a location from the origin, but may not be executing a navigation session.

In another example, having “not initiated a navigation session” may mean that the user computer device 102 is in a state requiring less battery usage and/or less processing power than when a navigation session has been initiated. For example, the user computer device 102 may consume relatively more power when the navigation application 108 has been launched as compared to prior to launch. In particular, a screen of the user computer device 102 may be on when the navigation session has been initiated in order to display information to a user, the user computer device 102 may actively stream map data from an external server 120 and/or vehicle computing device 150 while in a navigation session, etc.

In any event, in response to receiving the audio query, the navigation application 108 may communicate with the language processing module 109a, 120a at the user computing device 102 or the external server 120 to interpret the audio query.

More specifically, the user computing device 102 receives the audio query through an input device (e.g., microphone as part of the I/O module 118). The user computing device 102 then utilizes the processor 104 to execute instructions included as part of the language processing module 109a to transcribe the audio query into a set of text. The user computing device 102 may cause the processor 104 to execute instructions comprising, for example, an ASR engine (e.g., ASR engine 109a1) in order to transcribe the audio query from the speech-based input received by the I/O module 118 into the textual transcription of the user input. It should be appreciated that the execution of the ASR engine to transcribe the user input into the textual transcription may be performed by the user computing device 102, the external server 120, the vehicle computing device 150, and/or any other suitable component or combinations thereof.

This transcription of the audio query may then be analyzed, for example, by the processor 104 executing instructions comprising the language processing module 109a and/or the machine learning module 109b to interpret the textual transcription and determine attributes of the query, such as the origin. The user computing device 102 may identify the origin by comparing terms in the audio query to POIs from the POI database 159, addresses included in the map database 156, or predetermined origins/destinations stored in a user profile, such as “Home,” “Work,” “My Office,” etc.

In some implementations, the audio query does not include a point of origin or the language processing module 109a may identify a term corresponding to an origin, but the term refers to an origin category without specifying a particular point of origin (e.g., “the hotel”). In these scenarios, the ad-hoc query response engine 160 may infer the origin using navigation data and/or user context data, such as calendar data, typical destinations and/or origins at the particular day of the week/time of day, etc. For example, the ad-hoc query response engine 160 may obtain navigation data and/or user context data stored at the user computing device 102 or at the external server 120. The ad-hoc query response engine 160 may then analyze the navigation data and/or user context data in view of the audio query to infer the origin, any attributes, and/or a POI.

For example, if the audio query includes the origin or a POI as “the hotel” without specifying which hotel, the ad-hoc query response engine 160 may analyze recent navigation queries, set(s) of navigation directions, and/or map data requests which included hotels as destinations or POIs along the route(s). The ad-hoc query response engine 160 may also analyze the user context data to determine whether the user has booked a stay at a hotel, the user has a history of staying at a particular location when in the area (e.g., the user always stays at The Chicago Hotel when in Chicago), the user has passed a hotel recently, etc.

In further implementations, when the query does not include an origin, the ad-hoc query response engine 160 may infer the origin according to other data retrieved by the ad-hoc query response engine 160. For example, the ad-hoc query response engine 160 may obtain data from a GPS 112 or other sensor, stored at the user computing device 102 or at the external server 120, to determine that a user began moving. The ad-hoc query response engine 160 may then determine that the point where the user began moving is the origin. Similarly, the ad-hoc query response engine 160 may determine that a point where the user began moving at a speed above a predetermined threshold or began a trip that resulted in moving above a predetermined threshold is the origin.

In some implementations, such as when multiple hotels may correspond to “the hotel” based on recent navigation data and/or the context data, the ad-hoc query response engine 160 may rank the restaurants as candidate origins. For example, the candidate origins may be ranked according to the recency of the information. More specifically, a booking for a first hotel from the same day of the audio query may result in a higher ranking for the first hotel than a booking for a second hotel for the next day. The candidate origins may be scored and/or ranked using any suitable factors (e.g., recency of the search, likelihood that the user returns to the candidate origin at the particular time of day/day of the week, whether the candidate origin was recently passed, etc.).

In some implementations, the ad-hoc query response engine 160 may select the highest ranked or scored candidate origin as the origin, and may infer that the highest ranked or scored candidate origin is the origin referred to in the audio query. In other implementations, the ad-hoc query response engine 160 may only select a candidate origin when the candidate origin scores above a threshold score or has above a threshold likelihood of being the origin referred to in the audio query. Otherwise, the ad-hoc query response engine 160 may provide a response to the user asking the user to clarify the origin.

In addition to identifying the origin in the user's query regarding a previous or ongoing trip to return to the origin, the language processing module 109a may identify other attributes of the user's query. For example, the language processing module 109a may identify whether the user is asking to follow the same route or an improved route, whether the user is asking for particular characteristics of the route, whether the user is asking to reach the origin by a predetermined time, etc. The language processing module 109a may also identify specific parameters within the query, such as a specified duration to compare to the duration of the return trip (e.g., “Can you get me home by noon?” “Will I get to the restaurant in the next 15 minutes?” etc.), the distance to the origin, etc.

In any event, the ad-hoc query response engine 160 may analyze the origin, characteristics, and/or parameters included in the user's query or referred to in the user's query to respond to the user's query. More specifically, the ad-hoc query response engine 160 may obtain set(s) of navigation directions (e.g. from the external server) from the user's current location to the determined or inferred point of origin.

In some implementations, the ad-hoc query response engine 160 may generate and/or otherwise obtain location data for the user computing device 102. For example, the ad-hoc query response engine 160 may continuously or periodically obtain the current location of the user computing device 102 during a trip from the origin to the user location. The ad-hoc query response engine 160 may then temporarily record the obtained locations and/or use the obtained locations to determine a route from the user location to the origin, determine an origin in a user query, determine a POI, etc. Depending on the implementation, the sampling frequency for periodically obtaining the location data may be predetermined, may depend on attributes of the trip and/or region (e.g., if the trip is on a single road and the user is driving, then the sampling frequency can be low), based on attributes of the device (e.g., based on the available battery level), etc.

Based on the user query, the ad-hoc query response engine 160 may generate a route that includes some or all of the obtained locations. In some implementations, the ad-hoc query response engine 160 generates trip segments between recorded location data points and compiles the trip segments to generate the entire trip route. The ad-hoc query response engine 160 may additionally or alternatively determine to discard some obtained locations to improve the speed, mileage, power usage, etc. of the route. As such, the ad-hoc query response engine 160 may generate an improved route in response to the user query. In some implementations, the ad-hoc query response engine 160 may determine an expected trajectory as described herein to generate and/or filter out potential return routes.

The ad-hoc query response engine 160 may then analyze the navigation directions and/or location data to generate a response to the user query. In the example scenario 200, the ad-hoc query response engine 160 may determine that the origin in the query 202 is a home for the user. The ad-hoc query response engine 160 may obtain the location of the home, for example, from a user profile stored at the user computing device 102 or the external server 120. Then the ad-hoc query response engine 160 may obtain set(s) of navigation directions from the user's current location to the point of origin.

Then the ad-hoc query response engine 160 may generate a response to the user's query, for example, based on the attributes of the route. For example, when a route that includes a freeway is the fastest route, the ad-hoc query response engine 160 may generate a response indicating that the user should take the freeway. When there is an alternative route which would get the user to the point of origin faster, the ad-hoc query response engine 160 may generate a response indicating that the user should avoid the freeway. In another example, when the route that includes the freeway has a similar duration (e.g. the durations are within one or two minutes of each other or the difference in durations is less than a threshold difference) to an alternative route but the alternative route does not have as much traffic or construction, the ad-hoc query response engine 160 may generate a response indicating that the user should avoid the freeway. More generally, the response to the user's query may include one or more sets of navigation directions for traveling to the point of origin, route information for traveling to the point of origin, traffic information for traveling to the point of origin, a duration of a remaining portion of the current trip to the point of origin, a duration for a segment of the route (e.g., the highway portion of the route), traffic information for a segment of the route, etc. In some implementations, the ad-hoc query response engine 160 generates, retrieves, and/or otherwise provides navigation information for traveling to the point of origin that follow the same route that the user took to the user location by default. In such implementations, the ad-hoc query response engine 160 may prompt the user to determine whether the ad-hoc query response engine 160 should provide the default navigation information or provide an improved routing as described above. In further such implementations, the ad-hoc query response engine 160 instead determines that the user prefers an improved route suggestion based on the contents of the query.

Prior to the generation of the response, it may be that no navigation directions or travel information (such as that described above) are being provided to the user. Beneficially, the described process therefore minimizes battery usage and optimizes processing efficiency by only providing the navigation directions or travel information as a response to the user's query. Such benefits are present as the client device 10 or head unit 14, for example, may have their screens/displays powered off, be in a device sleep mode, or otherwise be in a device battery optimization mode until the response to the user's query is required to be provided as an output from such devices. The ad-hoc query response engine 160 may then provide a response 204 to the query as an audio output via a speaker, as a visual output on the user interface 116, and/or as a combination of audio/visual output. In implementations in which the user prefers an improved route in the response, the response may also indicate which part(s) of the route were improved upon, such as by noting the relevant portions of the route aloud (e.g., “You left Route 59 one exit too soon,”), by indicating the taken route and the improved route on a display, etc.

The user computing device 102 may generate the text of the response 204 by utilizing the language processing module 109a, and in certain aspects, a large language model (LLM) (e.g., language model for dialogue applications (LaMDA)) (not shown) included as part of the language processing module 109a. Such an LLM may be conditioned/trained to generate the response text based on characteristics of the response, and/or the LLM may be trained to receive a natural language representation of responses to requests for navigation information as input and to output a set of text representing the audio response based on the characteristics.

In any event, when the user computing device 102 fully generates the text of the response 204, the device 102 may proceed to synthesize the text into speech for audio output of the response to the user. In particular, the user computing device 102 may transmit the text of the response 204 to a TTS engine (e.g., TTS engine 109a2) in order to audibly output the response 204 through a speaker (e.g., speaker 26), so that the user may hear and interpret the response. Additionally, or alternatively, the user computing device 102 may also visually prompt the user by displaying the text of the response on a display screen (e.g., cluster display unit 151, user interface 116), so that the user may interact (e.g., click, tap, swipe, etc.) with the display screen and/or verbally acknowledge the response 204.

Further, it will be understood that, although FIG. 2 depicts a user driving a vehicle, the instant implementations may further apply to a user taking public transit, biking, walking, etc. For example, a user on vacation in San Francisco may walk from a hotel and end up in a nearby park. When the user begins the walk, a GPS 112 in the user computing device 102 determines that a trip has begun and marks the hotel location as the point of origin. The user computing device 102 may mark the user location at a predetermined time interval or at POIs, such as a café or restaurant. Depending on the implementation, the user computing device 102 may determine that a location is a POI based on user context information indicating that a user may be interested, based on interest expressed by the user, based on a third-party or separate ranking or reviews, based on a type of establishment, etc. The user may then ask the user computing device 102 to “Take me back,” as a query, and the ad-hoc query response engine 160 may subsequently guide the user back following the same route. Similarly, the user may instead ask, “Take me back to the café,” and the ad-hoc query response engine 160 will designate the café as the origin or as a point of interest, as described above.

FIG. 3 illustrates another example scenario 300 where a user requests navigation information without previously initiating a navigation session. In this scenario 300, the user asks whether the route from the point of origin to the current location was optimal. More specifically, the user asks, “Hey Maps, did I take the best route to get here?” 302. As in the example scenario 200, the user did not previously initiate a navigation session before providing this query regarding a previous or ongoing trip.

In the scenario 300, the user query includes a request regarding attributes for the route taken from the point of origin to the current location. Accordingly, the ad-hoc query response engine 160 may determine whether the route taken by the user from the origin to the current location is an optimal route or if alternative routes offer improvements. Depending on the implementation, the ad-hoc query response engine 160 may determine that the user query is for improvements in speed, mileage, power consumed, aesthetics (e.g., a quieter or more scenic route), etc. along the route. For example, the ad-hoc query response engine 160 and/or the language processing module 109a may determine what improvements are relevant to the user query using language processing as described herein. Additionally or alternatively, the ad-hoc query response engine 160 may assume that the user query is related to speed or time focused improvements and respond based on such unless the user indicates to the contrary.

The ad-hoc query response engine 160 may then compare the route the user took or a generated simulation of the route the user previously took to one or more alternative routes. Depending on the implementation, the ad-hoc query response engine 160 may determine the alternate routes by pulling navigation directions from the user computing device 102, the external server 120, the vehicle computing device 150, etc. In further implementations, the ad-hoc query response engine 160 instead determines the alternate routes by receiving navigation information from the user computing device 102, the external server 120, the vehicle computing device 150, etc. and generating alternative routes based on the navigation information and the point of origin.

The ad-hoc query response engine 160 may then compare the alternative routes to the previous user route to determine whether any alternative route includes an improvement to the estimated time taken to navigate the route, the estimated distance driven on the route, the estimated cost of the route, the estimated fuel used on the route, etc. When the ad-hoc query response engine 160 determines that the alternative routes do not include any relevant improvements, the client device 10 may inform the user that the user took the optimal path. Alternatively, when the ad-hoc query response engine 160 determines that an alternative route includes a relevant improvement, the client device 10 may inform the user in a query response 304. In some implementations, the client device 10 informs the user that one or more improved routes exist and provides a link to the user for various improved routes. In other implementations, the ad-hoc query response engine 160 determines a particular improved route to present to the user. Depending on the implementation, the ad-hoc query response engine 160 may make the determination based on a ranking using any suitable factors (e.g., route with the greatest improvement, route with the least tradeoff for improvement, route most similar to the past route with an improvement, etc.).

In implementations in which the client device 10 informs the user of an improved route in the query response 304, the client device 10 may only inform the user of part of the improved route. For example, if the route the user took diverges from the improved route, the client device 10 may inform the user of the point of divergence. As such, in scenario 300, the client device informs the user, “Actually, there was a slightly faster route if you would have exited the highway one stop later,” 304. Similarly, the response may also indicate which part(s) of the route were improved upon, such as by noting the relevant portions of the route aloud (e.g., “You left Route 59 one exit too soon,”), by indicating the taken route and the improved route on a display, etc.

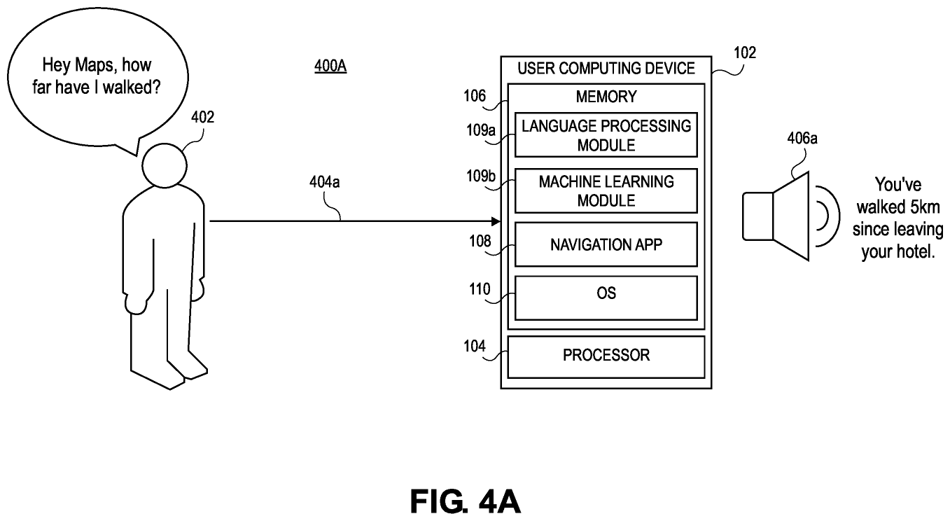

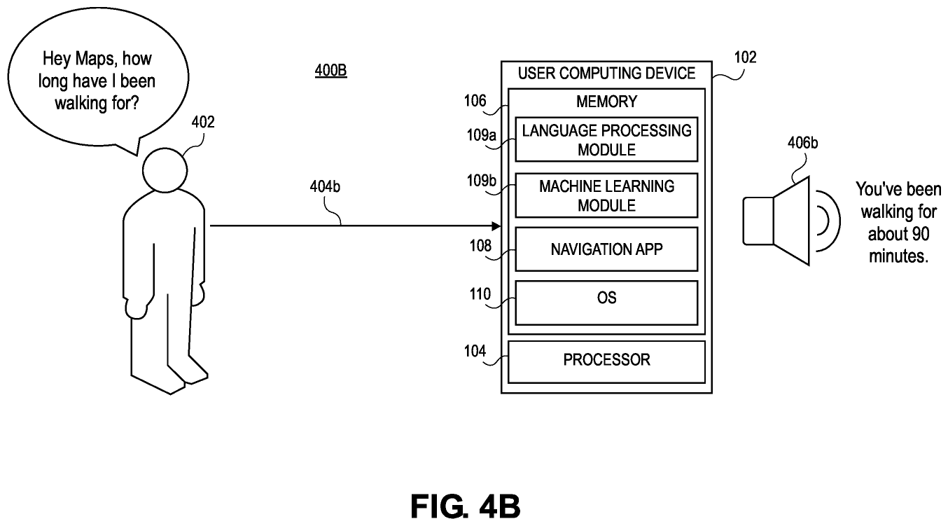

FIGS. 4A-7 illustrate example interactions between a user 402 and the user computing device 102 when the user requests navigation information prior to initiating a navigation session. In the example scenario 400A of FIG. 4A, the user 402 presents a query regarding a distance travelled. More specifically, the user 402 asks 404a, “Hey Maps, how far have I walked?”

The ad-hoc query response engine 160 may then determine a distance traveled by the user on a previous or current route. In some implementations, the ad-hoc query response engine 160 determines an origin as described herein to determine a past route taken by the user. In further implementations, the ad-hoc query response engine 160 further uses stored location data gathered by the user computing device 102 to generate the route. The ad-hoc query response engine 160 then subsequently calculates a distance traveled by the user along the route. In additional or alternative implementations, the ad-hoc query response engine 160 may instead track a distance using a GPS, accelerometer, etc. In some implementations, the navigation application 108 includes a pedometer or other distance-tracking functionality.

Depending on the implementation, the ad-hoc query response engine 160 may additionally filter by mode of transport. As such, the ad-hoc query response engine 160 may only calculate a distance covered in one mode of transport but not others. For example, a user asking a query 404a may have walked part of the way and driven the remainder. The ad-hoc query response engine 160 may determine that the user 402 is asking regarding walking, and may only consider walking segments but not driving segments in determining the distance traveled. Similarly, depending on the implementation, the ad-hoc query response engine 160 may respond with the entirety of the distance traveled, but note separately the total distance by form of travel (e.g., “You have traveled 5 km, 2 km of which was spent walking.”).

As a result, the user computing device 102 may generate a response 406a to the user query. For example, in the scenario 400A, the ad-hoc query response engine 160 determines that the user has walked 5 kilometers and the user computing device 102 informs the user “You've walked 5 km since leaving your hotel” in the response 406a.

Similarly, in the example scenario 400B of FIG. 4B, the user 402 presents a query regarding time spent traveling. More specifically, the user 402 asks 404b, “Hey Maps, how long have I been walking for?”

The ad-hoc query response engine 160 may then determine a time spent traveling by the user on a previous or current route. In some implementations, the ad-hoc query response engine 160 determines an origin as described herein to determine a past route taken by the user. In further implementations, the ad-hoc query response engine 160 further uses stored location data gathered by the user computing device 102 to generate the route. The ad-hoc query response engine 160 then subsequently calculates an estimated time spent to traverse the route by the user. In some implementations, the ad-hoc query response engine 160 uses an estimated movement speed based on a user form of transportation (e.g., walking, driving, biking, etc.) to calculate the estimated time spent to traverse the route by the user. In further implementations, the ad-hoc query response engine 160 uses an actual movement speed based on one or more sensors of the user computing device 102 (e.g., a GPS, an accelerometer, etc.). In still further implementations, the ad-hoc query response engine 160 uses a clock, timer, and/or a timer functionality of the navigation application 108 upon determining that the user 402 has begun a trip to measure the time spent traveling.

As a result, the user computing device 102 may generate a response 406b to the user query. For example, in the scenario 400B, the ad-hoc query response engine 160 determines that the user has walked for approximately 90 minutes, and the user computing device 102 informs the user “You've been walking for about 90 minutes” in the response 406b.

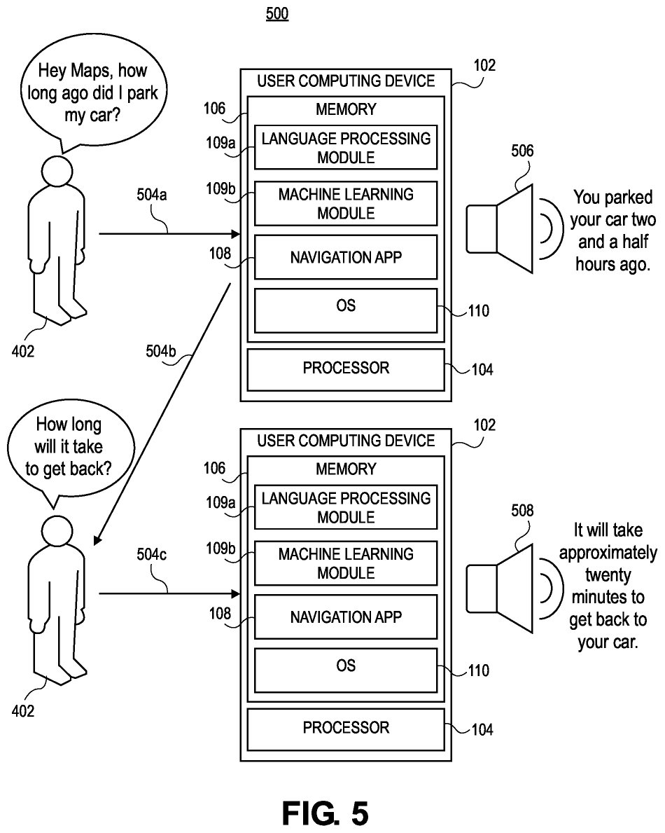

FIG. 5 illustrates an example scenario 500 which is similar to the example scenarios 400A and 400B of FIGS. 4A and 4B. In the example scenario 500, the user 402 asks 504a, “Hey Maps, how long ago did I park my car?” This is a similar user query as in the example scenario 400B. Accordingly, the user computing device 102 determines a period of time that has passed since the user 402 left the origin (e.g., the POI of leaving the car). In some implementations, the user computing device 102 determines that the user 402 has left the origin in response to detecting a change in speed (e.g., the user computing device 102 goes from speeds typical of a car to speeds typical of walking). In further implementations, the user computing device 102 accesses an external application or other user context data to determine that the user 402 has left the car (e.g., the user computing device 102 stops receiving a signal that pairs the user computing device 102 with the vehicle). As a result, the user computing device 102 may transmit 504b a first response 506 to the user 402 providing the information to the user. For example, in the example scenario 500, the user computing device 102 responds, “You parked your car two and a half hours ago.”

The user 402 may end the conversation with the user computing device 102 after receiving the response 506 or may ask 504c a follow-up question to the user computing device 102. For example, the user 402 may ask a related question such as “How long will it take to get back?” In some implementations, the ad-hoc query response engine 160 uses the first query to determine a context of the second query (e.g., determining that the user 402 is referring to the car). The ad-hoc query response engine 160 may then generate the route back to the car as described herein and determine an estimated distance, time, etc. to the car. The user computing device 102 may then provide the second response 508 to the user's query regarding a previous or ongoing trip as an audio output via a speaker, as a visual output on the user interface 116 and/or as a combination of audio/visual output.

It should be noted that the user computing device 102 may generally allow the user 402 several seconds (e.g., 5-10 seconds) to respond following transmission of the first response 506 which includes an audio query through the speaker 26 in order to give the user 402 enough time to think of a proper response without continually listening to the interior of the automobile. By default, the user computing device 102 may not activate a microphone and/or other listening device (e.g., included as part of the I/O module 118) while running the navigation app 108, and/or while processing information received through the microphone by, or in accordance with, for example, the processor 104, the language processing module 109a, the machine learning module 109b, and/or the OS 110. Thus, the user computing device 102 may not actively listen to a vehicle interior during a navigation session and/or at any other time, except when the user computing device 102 provides an audio query to the user 402, to which, the user computing device 102 may expect a verbal response from the user 402 within several seconds of transmission.

In some implementations, the first response 506 or the second response 508 is a request for clarification to the user. In such implementations, the ad-hoc query response engine 160 may not be able to determine the contents of the user query, and may prompt the user 402 to clarify details, such as whether the POI and/or origin is the parked car, home, a hotel, etc. The user 402 may then respond by transmitting a clarification response and the user computing device 102 may proceed accordingly.

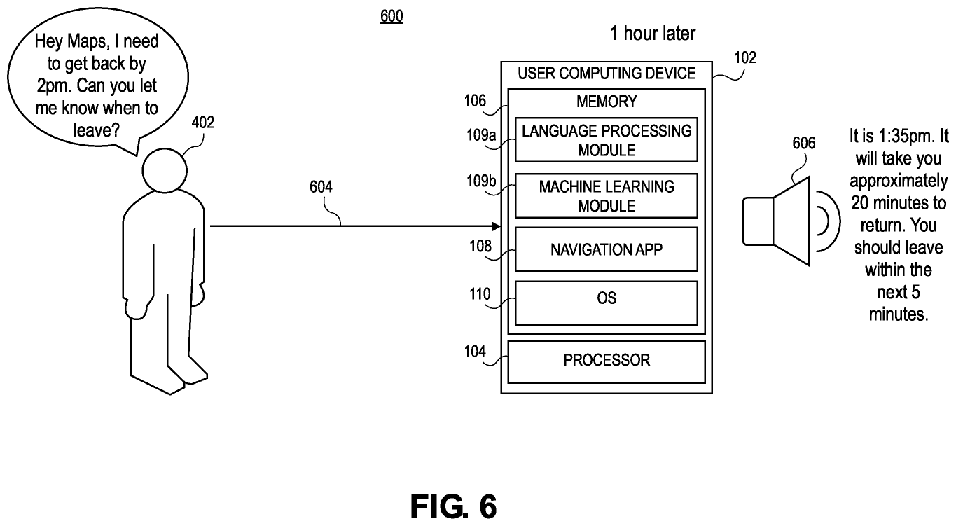

FIG. 6 illustrates an example scenario 600 which is similar to the example scenarios 400A, 400B, and 500 of FIGS. 4A-5. In the example scenario 600, the user 402 asks 604, “Hey Maps, I need to get back by 2 pm. Can you let me know when to leave?” Depending on the implementation, the user computing device 102 can display a message, notification, audio cue, etc. to alert the user that the user computing device 102 received the query.

The ad-hoc query response engine 160 may then determine an estimated time for the user to return back to the origin, as described herein. Based on the calculated estimated time and the information provided by the user in the query 604, the ad-hoc query response engine 160 may then calculate a time at which the user computing device should alert the user to begin the return trip. In some implementations, the ad-hoc query response engine 160 includes a window of leeway time, based on user settings, an indication in the user query 604, a range of expected uncertainty, etc. and alerts the user within the window of leeway time. For example, in the example scenario 600, after an hour, the user computing device 102 provides a response 606 to the user query, noting, “It is 1:35 PM. It will take you approximately 20 minutes to return. You should leave within the next 5 minutes.”

In some implementations, the ad-hoc query response engine 160 determines that parking for a user (e.g., according to an app, a user note, etc.) will expire at a certain time and alert the user to begin returning to the parked car with enough time for the user to reach the car before the parking expires. Depending on the implementation, the ad-hoc query response engine 160 may alert the user in response to a request, a setting on the navigation application 108, automatically, etc.

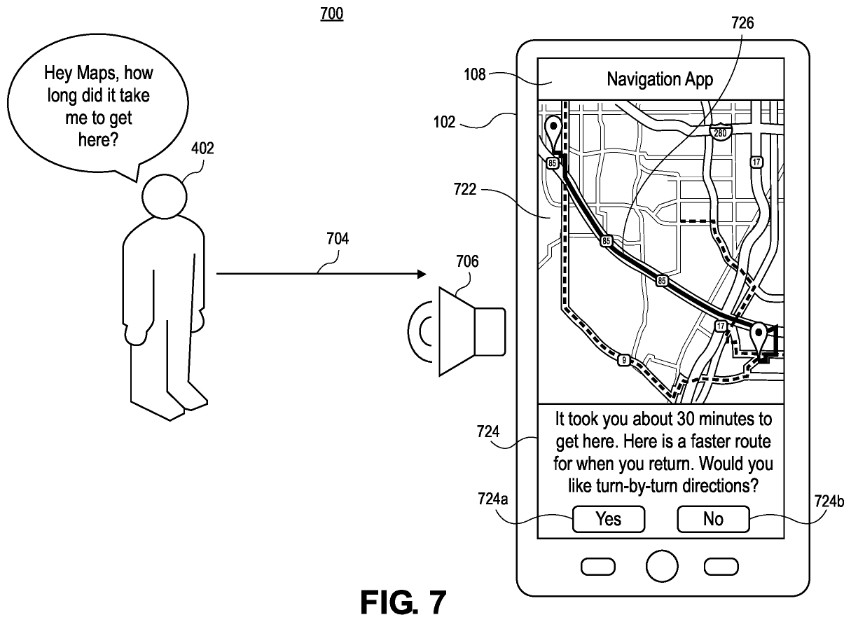

FIG. 7 illustrates yet another example scenario 700 where the user computing device prompts the user 402 to initiate a navigation session in response to the user's query regarding a previous or ongoing trip. In the example scenario 700, the user asks 704, “Hey Maps, how long did it take me to get here?” The ad-hoc query response engine 160 may determine the time and/or distance it took to reach the current location from a point of origin as discussed herein.

Accordingly, the user computing device 102 may generate a response 706 to the user's 402 query indicating that the user 402 travelled for approximately 30 minutes to get to the current location. However, there is a faster route 726 for the user 402 return trip. The response 706 may be presented as an audio response 706 and additionally or alternatively as a text response 724 on the user interface 116 of the user computing device 102. Also, the text response 724 and/or the audio response 706 may include a prompt with user controls 724a, 724b for the user 402 to select whether they want to receive turn-by-turn directions for the faster route 726. In response to receiving a selection of the user control 724a indicating that the user 402 would like to initiate a navigation session (e.g., via a touch selection or audio input), the user computing device 102 may initiate the navigation session and provide navigation directions for the faster route to return home as audio directions and/or via a navigation display 722 on the user computing device 102.

### Example Method for Providing Information Regarding a Previous or Ongoing Trip

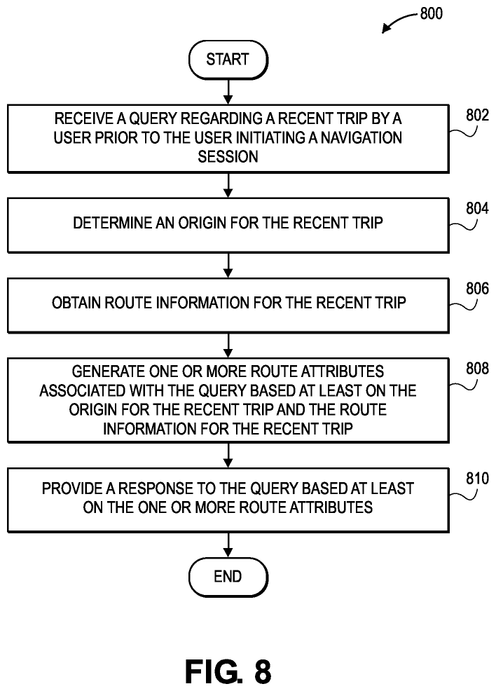

FIG. 8 is a flow diagram of an example method 800 for providing route information regarding a completed or ongoing trip by a user without the user having previously initiated a navigation session, which can be implemented in a computing device, such as the user computing device 102 of FIG. 1. It is to be understood that, throughout the description of FIG. 8, actions described as being performed by the user computing device 102 may, in some implementations, be performed by the external server 120, the vehicle computing device 150, and/or may be performed by the user computing device 102, the external server 120, and/or the vehicle computing device 150 in parallel. For example, the user computing device 102, the external server 120, and/or the vehicle computing device 150 may utilize the language processing module 109a, 120a, 153a and/or the machine learning module 109b, 120c, 153c to provide route information.

The method 800 can be implemented in a set of instructions stored on a computer-readable memory and executable at one or more processors of the user computing device 102 (e.g., the processor(s) 104). For example, the method 800 may be executed by the ad-hoc query response engine 160.

At block 802, the ad-hoc query response engine 160 may receive a query regarding a previous or ongoing trip by a user prior to the user initiating a navigation session. In some implementations, the ad-hoc query response engine 160 receives the query as an audio query or via text input. The user may provide a particular trigger phrase or hot word which causes the ad-hoc query response engine 160 to receive the audio query from the user, such as “Hey Maps.” In further implementations, the user may not have launched the navigation application 108 prior to providing the query. In other implementations, the navigation application 108 may be activated and may continuously or periodically obtain location data for the user computing device 102 for example, to determine a location of the user computing device 102 but may not be executing a navigation session.

Then at block 804, the ad-hoc query response engine 160 may determine an origin for a previous or ongoing trip by the user. Depending on the implementation, the previous or ongoing trip may be a trip completed within a predetermined period of time, the most recently completed trip, an ongoing trip, etc. In some implementations, the ad-hoc query response engine 160 identifies the origin by comparing terms in the query regarding a previous or ongoing trip to POIs from the POI database 159, addresses included in the map database 156, or predetermined destinations and/or trip starting points stored in a user profile, such as “Home,” “Work,” “My Office,” etc.

In further implementations, the query does not include an origin or the language processing module 109a may identify a term corresponding to an origin or point-of-interest, but the term refers to a broader category without specifying a particular destination (e.g., “Take me back to that restaurant I passed”). In these scenarios, the ad-hoc query response engine 160 may infer the origin using generated route information, location data, and/or user context data, such as calendar data, typical trips taken at the particular day of the week/time of day, etc. In other implementations, the ad-hoc query response engine 160 may only select a candidate origin when the candidate origin has above a threshold likelihood of being the origin referred to in the audio query. Otherwise, the ad-hoc query response engine 160 may provide a response to the user asking the user to clarify the origin and/or destination.

In still further implementations, the ad-hoc query response engine 160 may determine that a location is an origin after determining that the user stayed in one relative place for more than a predetermined period of time before beginning to move. For example, if the user stays within the same one block radius for 8 hours, the ad-hoc query response engine 160 may determine that the user is at home, at work, at a hotel, etc. Depending on the implementation, the predetermined period of time may be 24 hours, 12 hours, 8 hours, 1 hour, 30 minutes, etc. In further implementations, the ad-hoc query response engine 160 may determine that the user is in one relative place when the user remains within a one mile radius, within a one block radius, within the confines of one house or building, etc. In some implementations, the ad-hoc query response engine 160 determines that the user moves from a location based on communications and/or indications from a GPS 112 of the user device 102.

It will be understood that, although the term “origin” is used herein, that the origin does not necessarily refer solely to the beginning point of a trip. For example, the origin may further refer to a location of an event, a particular POI, etc. As such, origin may additionally be used herein to refer to such locations.

At block 806, the ad-hoc query response engine 160 may obtain route information for a previous or ongoing trip by the user. In some implementations, the route information is generated during the previous or ongoing trip and stored at a memory 106 of the user computing device 102, a memory 153 of a vehicle computing device, and/or a database (such as a map database 156) of an external server 120. In such implementations, the ad-hoc query response engine 160 may obtain the route information by retrieving the route information from the respective memory, database, server, etc. In other implementations, the ad-hoc query response engine 160 generates the route information after the trip is completed and/or responsive to receiving the query at block 802. In such implementations, the ad-hoc query response engine 160 may generate the route information using stored particular route data points (such as POIs, events, the origin, etc.), GPS information, map information, etc. Depending on the implementation, the route information may include points of interest along a route, navigation instructions for the route, trajectory information associated with the route, trajectory information associated with an initial route mirroring the route, etc.

At block 808, the ad-hoc query response engine 160 may generate one or more route attribute(s) associated with the query based at least on the origin and the route information for the previous or ongoing trip. Depending on the implementation, the route attribute(s) associated with the query may include any of: (i) a current location for the user, (ii) a travel time for the previous or ongoing trip, (iii) a travel distance for the previous or ongoing trip, (iv) a fuel consumption for the previous or ongoing trip, (v) a fuel consumption rate for the previous or ongoing trip, (vi) a return route from the current location to the origin (e.g., a route tracing the reverse of the same path the user took from the origin to the current location), (vii) an improved route from the current location to the origin (e.g., a route from the current location to the origin that is faster, more fuel efficient, lower mileage, etc. than the original path from the origin to the current location), (viii) a route distance from an event location to the current location, (ix) a route time from a time of an event to the current location, (x) a subjective and/or aesthetic score for the route (e.g., how quiet, scenic, etc. the route is), or (xi) any other similar route attribute as described herein. Depending on the implementation, the ad-hoc query response engine 160 may generate the one or more route attributes by extracting information from the route information obtained at block 806. For example, the ad-hoc query response engine 160 may extract data regarding a travel distance from a map of the route the user followed for the previous or ongoing trip. In further implementations, the ad-hoc query response engine 160 may extract data regarding fuel consumption from a vehicle computing device 150. As another example, the ad-hoc query response engine 160 may extract information regarding aesthetics of a route (e.g., an aesthetic rating) from one or more user scores associated with at least part of the route.

Alternatively or additionally, the ad-hoc query response engine 160 may generate the one or more route attribute(s) by calculating the attribute using the route information, origin, and/or other relevant information. For example, to calculate the fuel consumption, the ad-hoc query response engine 160 may use the route information and determined origin along with a fuel efficiency of a current car (e.g., retrieved from the vehicle computing device 150) to determine the overall fuel consumption from the previous trip.

In some implementations, the query includes a request as to whether the user took the most optimal route with regard to at least one route attribute (e.g., distance travelled, time travelled, fuel consumed, etc.). In some implementations, the ad-hoc query response engine 160 determines that the query includes such a request in response to determining that the query included a particular word or phrase (e.g., “best route,” “fastest route,” “shortest route,” “efficient route,” etc.). Depending on the implementation, the ad-hoc query response engine 160 may make such a determination using natural language processing techniques as described herein. In such implementations, the ad-hoc query response engine 160 generates a hindsight route optimized for the relevant characteristic. For example, if the user asks if she took the “fastest route”, the ad-hoc query response engine 160 generates a hindsight route that takes the least estimated time to traverse. In some implementations, the ad-hoc query response engine 160 generates multiple routes and determines a route to designate and/or use as the hindsight route. In further implementations, the ad-hoc query response engine 160 determines to designate multiple routes as hindsight routes. Depending on the implementation, the ad-hoc query response engine 160 may periodically store parameters such as traffic conditions and, when a user requests a hindsight route analysis, the ad-hoc query response engine 160 may subsequently access the parameters to generate the hindsight route(s) using conditions that were present when the user was traveling.

After generating hindsight route(s) for the user, the ad-hoc query response engine 160 may compare the route information (including the route attribute(s)) to the hindsight route to determine whether the hindsight route includes improvements to the relevant characteristic for the previous or ongoing trip. Depending on the implementation, the ad-hoc query response engine 160 may reverse the order of events and analyze multiple routes first, then designate any route with an improvement compared to the route the user previously traversed as a hindsight route.

Similarly, in some implementations, the query may include a return time and a request for a notification to return by said time (e.g., “Let me know when to leave so I get home by 2:00 PM.”). In some such implementations, the ad-hoc query response engine 160 further calculates an outbound time for the user to begin a route back to the origin based at least on the route information and the origin. In further implementations, the ad-hoc query response engine 160 may further utilize information such as historical data for the user in determining the outbound time (e.g., the user always drives 5 mph below the speed limit, the user avoids tollways, the user avoids residential areas, etc.). The ad-hoc query response engine 160 may determine a time to alert the user to leave and provide the information in a response at such a time, as detailed below.

At block 810, the ad-hoc query response engine 160 may provide a response to the query regarding the previous or ongoing trip based at least on the generated route attribute(s). The ad-hoc query response engine 160 may generate the text of the response by utilizing the language processing module 109a, and in certain aspects, an LLM (e.g., LaMDA) included as part of the language processing module 109a. Such an LLM may be conditioned/trained to generate the response text based on characteristics of the response, and/or the LLM may be trained to receive a natural language representation of responses to requests for navigation information as input and to output a set of text representing the audio response based on the characteristics.

In any event, when the ad-hoc query response engine 160 fully generates the text of the response, the user computing device 102 may proceed to synthesize the text into speech for audio output of the response to the user. In particular, the user computing device 102 may transmit the text of the response to a TTS engine (e.g., TTS engine 109a2) in order to audibly output the response through a speaker (e.g., speaker 206), so that the user may hear and interpret the response. Additionally, or alternatively, the user computing device 102 may also visually prompt the user by displaying the text of the response on a display screen (e.g., cluster display unit 151, user interface 116), so that the user may interact (e.g., click, tap, swipe, etc.) with the display screen and/or verbally acknowledge the response.

The response to the query may include the relevant route information, route attributes, etc. In implementations in which the ad-hoc query response engine 160 generates hindsight route(s) for the user, the response may include a top hindsight route or hindsight routes, as well as a listing of improvements and/or where improvements are potentially applicable (e.g., “It would have been 5 minutes faster to take a left at 34 and Orchard.”). Similarly, in implementations in which the user requests a return route, the response may include the return route. In implementations in which the user requests for a notification, the response may include the notification and may occur at a determined time, at a time requested by the user, at a predetermined period before the determined time, etc.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 800 may include one or more function blocks, modules, individual functions or routines in the form of tangible computer-executable instructions that are stored in a computer-readable storage medium, optionally a non-transitory computer-readable storage medium, and executed using a processor of a computing device (e.g., a server device, a personal computer, a smart phone, a tablet computer, a smart watch, a mobile computing device, or other client computing device, as described herein). The method 800 may be included as part of any backend server (e.g., a map data server, a navigation server, or any other type of server computing device, as described herein), client computing device modules of the example environment, for example, or as part of a module that is external to such an environment. Though the figures may be described with reference to the other figures for case of explanation, the method 800 can be utilized with other objects and user interfaces. Furthermore, although the explanation above describes steps of the method 800 being performed by specific devices (such as a user computing device), this is done for illustration purposes only. The blocks of the method 800 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for determining places and routes through natural conversation through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for providing route information regarding a completed or ongoing trip by a user without the user having previously initiated a navigation session, the method comprising:
receiving, at one or more processors, a query regarding a previous or ongoing trip by a user prior to the user initiating a navigation session;
determining, by the one or more processors, an origin for the previous or ongoing trip;
obtaining, by the one or more processors, route information for the previous or ongoing trip;
generating, by the one or more processors, one or more route attributes associated with the query based at least on the origin for the previous or ongoing trip and the route information for the previous or ongoing trip; and
providing, by the one or more processors, a response to the query based at least on the one or more route attributes.

2. The method of claim 1, wherein the query regarding the previous or ongoing trip is received prior to launching a mapping application.

3. The method of claim 1, wherein:
the query regarding the previous or ongoing trip includes a request for feedback on the route information;
the one or more route attributes include a current location for the user and at least one of a travel time, travel distance, aesthetic rating, or fuel consumption for the previous or ongoing trip; and
the method further includes:
generating, by the one or more processors, a hindsight route from the origin to the current location, and
determining, by the one or more processors and by comparing the route information to the hindsight route, whether the hindsight route includes improvements to at least one of the travel time, the travel distance, aesthetic rating, or the fuel consumption for the previous or ongoing trip compared to the route information;
wherein the response to the query includes the hindsight route when the hindsight route includes the improvements.

4. The method of claim 1, wherein:
the query regarding the previous or ongoing trip includes a request to return to the origin;
the one or more route attributes includes a current location for the user; and
the method further includes:
generating, by the one or more processors and based on the route information, a return route from the current location to the origin;
wherein the response to the query includes the return route.

5. The method of claim 1, wherein:
the query regarding the previous or ongoing trip includes a request for information regarding at least one of a route distance or a route time;
generating the one or more route attributes further includes:
determining, by the one or more processors, a current location for the user, and
calculating, by the one or more processors, the at least one of the route distance or the route time based at least on the route information;
wherein the response to the query includes the at least one of the route distance or the route time.

6. The method of claim 5, wherein:
the request for information regarding the at least one of the route distance or the route time includes an event;
the at least one of the route distance or the route time is at least one of a route distance from a location of the event or a route time from a time of the event; and
the method further includes:
determining, by the one or more processors, at least one of the location of the event or the time of the event based at least on the request for information and the route information.

7. The method of claim 1, wherein:
the query regarding the previous or ongoing trip includes a return time and a request for a notification to return; and
the method further includes:
calculating, by the one or more processors, an outbound time for the user to begin a route back to the origin based at least on the route information and the origin;
wherein providing the response to the query includes providing the notification to return at least at one of: (i) the calculated outbound time or (ii) a predetermined period before the calculated outbound time.

8. The method of claim 1, wherein the query is an audio query and the response to the query is an audio response.

9. A computing device for providing route information regarding a completed or ongoing trip by a user without the user having previously initiated a navigation session, the computing device comprising:
one or more processors; and
a computer-readable memory coupled to the one or more processors and storing instructions thereon that, when executed by the one or more processors, cause the computing device to:
receive a query regarding a previous or ongoing trip by a user prior to the user initiating a navigation session;
determine an origin for the previous or ongoing trip;
obtain route information for the previous or ongoing trip;
generate one or more route attributes associated with the query based at least on the origin for the previous or ongoing trip and the route information for the previous or ongoing trip; and
provide a response to the query based at least on the one or more route attributes.

10. The computing device of claim 9, wherein the query regarding the previous or ongoing trip is received prior to launching a mapping application.

11. The computing device of claim 9, wherein:
the query regarding the previous or ongoing trip includes a request for feedback on the route information;
the one or more route attributes include a current location for the user and at least one of a travel time, travel distance, aesthetic rating, or fuel consumption for the previous or ongoing trip; and
the instructions further cause the computing device to:
generate a hindsight route from the origin to the current location, and
determine, by comparing the route information to the hindsight route, whether the hindsight route includes improvements to at least one of the travel time, the travel distance, aesthetic rating, or the fuel consumption for the previous or ongoing trip compared to the route information;
wherein the response to the query includes the hindsight route when the hindsight route includes the improvements.

12. The computing device according to claim 9, wherein:
the query regarding the previous or ongoing trip includes a request to return to the origin;
the one or more route attributes includes a current location for the user; and
the instructions further cause the computing device to:
generate, based on the route information, a return route from the current location to the origin;
wherein the response to the query includes the return route.

13. The computing device according to claim 9, wherein:
the query regarding the previous or ongoing trip includes a request for information regarding at least one of a route distance or a route time;
generating the one or more route attributes further includes:
determining a current location for the user, and
calculating the at least one of the route distance or the route time based at least on the route information;
wherein the response to the query includes the at least one of the route distance or the route time.

14. The computing device of claim 13, wherein:
the request for information regarding the at least one of the route distance or the route time includes an event;
the at least one of the route distance or the route time is at least one of a route distance from a location of the event or a route time from a time of the event; and
the instructions further cause the computing device to:
determine at least one of the location of the event or the time of the event based at least on the request for information and the route information.

15. The computing device according to claim 9, wherein:
the query regarding the previous or ongoing trip includes a return time and a request for a notification to return; and
the instructions further cause the computing device to:
calculate an outbound time for the user to begin a route back to the origin based at least on the route information and the origin;
wherein providing the response to the query includes providing the notification to return at least at one of: (i) the calculated outbound time or (ii) a predetermined period before the calculated outbound time.

16. The computing device according to claim 9, wherein the query is an audio query and the response to the query is an audio response.

17. A computer-readable medium storing instructions for providing route information regarding a completed or ongoing trip by a user without the user having previously initiated a navigation session, that when executed by one or more processors cause the one or more processors to:
receive a query regarding a previous or ongoing trip by a user prior to the user initiating a navigation session;
determine an origin for the previous or ongoing trip;
obtain route information for the previous or ongoing trip;
generate one or more route attributes associated with the query based at least on the origin for the previous or ongoing trip and the route information for the previous or ongoing trip; and
provide a response to the query based at least on the one or more route attributes.

18. The computer-readable medium of claim 17, wherein the query regarding the previous or ongoing trip is received prior to launching a mapping application.

19. The computer-readable medium of claim 17, wherein:
the query regarding the previous or ongoing trip includes a request for feedback on the route information;
the one or more route attributes include a current location for the user and at least one of a travel time, travel distance, aesthetic rating, or fuel consumption for the previous or ongoing trip; and
the instructions further cause the computing device to:
generate a hindsight route from the origin to the current location, and
determine, by comparing the route information to the hindsight route, whether the hindsight route includes improvements to at least one of the travel time, the travel distance, aesthetic rating, or the fuel consumption for the previous or ongoing trip compared to the route information;
wherein the response to the query includes the hindsight route when the hindsight route includes the improvements.

20. The computer-readable medium according to claim 17, wherein:
the query regarding the previous or ongoing trip includes a request to return to the origin;
the one or more route attributes includes a current location for the user; and
the instructions further cause the computing device to:
generate, based on the route information, a return route from the current location to the origin;
wherein the response to the query includes the return route.
